(19) United States
(12) Patent Application Publication
(10) Pub. No.: US 2025/0113351 A1
(43) Pub. Date: Apr. 3, 2025

(54) ENHANCED SCHEDULING REQUEST

(71) Applicant: QUALCOMM Incorporated, San Diego, CA (US)

(72) Inventors: Ashutosh GUPTA, Gangapur City (IN); Harinath Reddy PATEL, Hyderabad (IN); Ravi SHUKLA, Hyderabad (IN)

(21) Appl. No.: 18/479,021

(22) Filed: Sep. 30, 2023

(51) Int. Cl. H04W 72/1268; H04W 76/28; H04W 76/30

(52) U.S. Cl. CPC H04W 72/1268; H04W 76/28; H04W 76/30

(57) ABSTRACT

Various aspects of the present disclosure generally relate to wireless communication. In some aspects, a user equipment (UE) may select information indicating a request or a notification that is independent of a request for an uplink grant. The UE may transmit the information in a message associated with a scheduling request. Numerous other aspects are described.

### FIELD OF THE DISCLOSURE

Aspects of the present disclosure generally relate to wireless communication and to techniques and apparatuses for an enhanced scheduling request.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include selecting information indicating a request or a notification that is independent of a request for an uplink grant. The method may include transmitting the information in a message associated with a scheduling request.

Some aspects described herein relate to a method of wireless communication performed by a network entity. The method may include receiving a first message associated with a scheduling request, the first message including information indicating a request or a notification that is independent of a request for an uplink grant. The method may include performing an action in accordance with the information.

Some aspects described herein relate to an apparatus for wireless communication at a UE. The apparatus may include one or more memories and one or more processors coupled to the one or more memories. The one or more processors may be individually or collective configured to cause the UE to select information indicating a request or a notification that is independent of a request for an uplink grant. The one or more processors may be individually or collective configured to cause the UE to transmit the information in a message associated with a scheduling request.

Some aspects described herein relate to an apparatus for wireless communication at a network entity. The apparatus may include one or more memories and one or more processors coupled to the one or more memories. The one or more processors may be individually or collective configured to cause the network entity to receive a first message associated with a scheduling request, the first message including information indicating a request or a notification that is independent of a request for an uplink grant. The one or more processors may be individually or collective configured to cause the network entity to perform an action in accordance with the information.

Some aspects described herein relate to a non-transitory computer-readable medium that stores a set of instructions for wireless communication by a UE. The set of instructions, when executed by one or more processors of the UE, may cause the UE to select information indicating a request or a notification that is independent of a request for an uplink grant. The set of instructions, when executed by one or more processors of the UE, may cause the UE to transmit the information in a message associated with a scheduling request.

Some aspects described herein relate to a non-transitory computer-readable medium that stores a set of instructions for wireless communication by a network entity. The set of instructions, when executed by one or more processors of the network entity, may cause the network entity to receive a first message associated with a scheduling request, the first message including information indicating a request or a notification that is independent of a request for an uplink grant. The set of instructions, when executed by one or more processors of the network entity, may cause the network entity to perform an action in accordance with the information.

Some aspects described herein relate to an apparatus for wireless communication. The apparatus may include means for selecting information indicating a request or a notification that is independent of a request for an uplink grant. The apparatus may include means for transmitting the information in a message associated with a scheduling request.

Some aspects described herein relate to an apparatus for wireless communication. The apparatus may include means for receiving a first message associated with a scheduling request, the first message including information indicating a request or a notification that is independent of a request for an uplink grant. The apparatus may include means for performing an action in accordance with the information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a scheduling request (SR), in accordance with the present disclosure.

FIG. 5 is a diagram illustrating an example associated with an enhanced SR, in accordance with the present disclosure.

FIG. 6 is a diagram illustrating an example of a bandwidth part switch, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network entity or an apparatus of a network entity, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects relate generally to wireless communications. Some aspects more specifically relate to requests from a UE to the network. In some examples, a user equipment (UE) may transmit a scheduling request (SR) to request an uplink (UL) grant. A physical uplink control channel (PUCCH) format 0 or 1 is used to send the SR, which can carry two bits or less. Currently, SR bit information is one bit, and an acknowledgement (ACK) or negative ACK (NACK) is the other bit. The SR bit only asks for an UL grant. The network entity (e.g., gNB) may transmit downlink control information (DCI) with the UL grant. The UE may then transmit a discontinuous reception (DRX) request and receive a DRX command. The UE may then go to sleep. This process involves at least four steps, which consumes signaling resources.

The UE may transmit an SR in relation to a connected mode DRX (CDRX) mode. A CDRX mode of a UE may include periodic DRX cycles, where each DRX cycle includes an active duration, during which the UE uses power for transmission, and an inactive duration, during which the UE reduces its power and does not transmit signals (or does not transmit certain signals). In some examples, when the UE is in an inactive duration, the UE may enter a sleep state. Sleeping may involve turning off a radio and one or more other components or functions. Turning off or switching off a radio may include removing power from the radio such that the radio is not fully operating or not operating with full power. The UE may wake up for an active duration. Waking up may involve turning on a radio and one or more other components or functions. Turning on or switching on a radio may include adding power to the radio such that the radio is fully operating or operating with full power.

Networks may configure CDRX with a 100 millisecond (ms) inactivity timer. The UE may start the inactivity timer after transmitting or receiving a communication and enter an inactive mode when the timer expires. This allows the UE to conserve power. The network may also configure the UE with a 160 ms long DRX cycle. The UE may enter DRX early when using a shorter data burst timer to provide an opportunity for the UE to sleep for some time for these application traffic patterns. This can help to save a significant amount of modem power while upper bounding the delay impact. However, for many applications, due to the traffic arrival process, the UE may not get any opportunity to transition to DRX inactive mode in some configurations. This wastes UE power.

According to various aspects described herein, the UE may transmit an enhanced SR that includes information other than (and is independent of) a request for an UL grant. The information may include a request or an indication that is not a request for an UL grant. That is, the UE may transmit an SR with the information and without a request for an UL grant. For example, if the UE is to take advantage of early DRX and go to sleep early, the UE may transmit an enhanced SR with information that includes a request for a DRX medium access control (MAC) control element (MAC CE) (a network command to go to sleep). By transmitting the request for the DRX MAC CE in the enhanced SR, the UE may request and receive the DRX MAC CE earlier than if the UE were to follow a process where the UE transmits an SR with an UL grant (in order to transmit the DRX request), receives DCI with the UL grant, and then requests and receives the DRX MAC CE. Using fewer steps allows the UE to sleep earlier, conserve power, and conserve signaling resources. This may also avoid scenarios where the DRX inactivity timer is restarted with the sending of the UL grant, which prevents the UE from going to sleep until the new DRX inactivity timer expires. The enhanced SR allows a request or an indication to be handled at a lower layer (physical (PHY) layer) instead of at the MAC or radio resource control (RRC) layers. The handling at the lower layer is faster and consumes less signaling resources and power. Enhanced SR values may be operator controlled and/or agreed upon between the network entity and the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

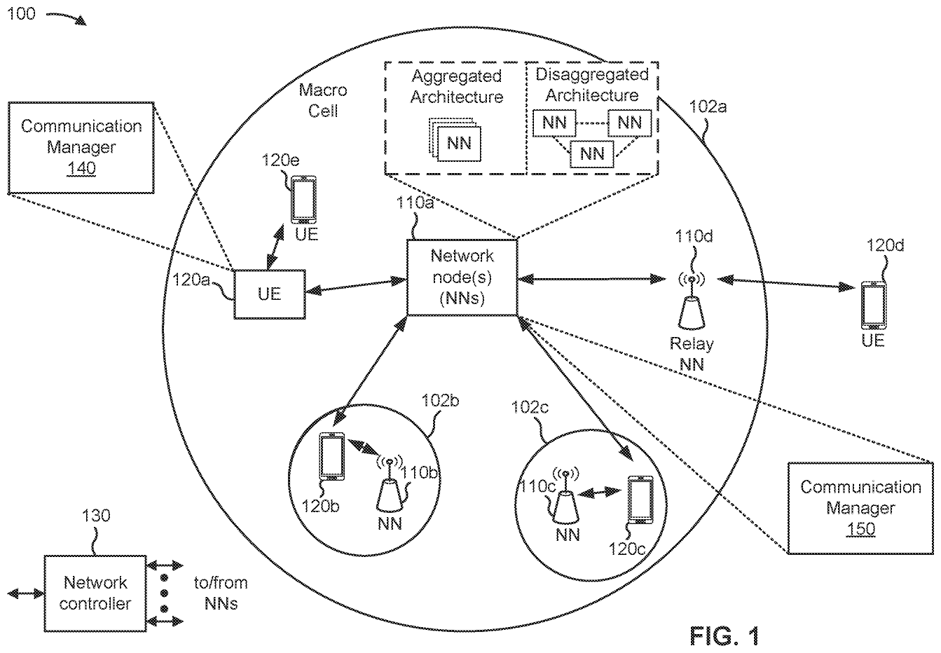

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may select information indicating a request or a notification that is independent of a request for an UL grant. The communication manager 140 may transmit the information in a message associated with a scheduling request. Additionally, or alternatively, the communication manager 140 may perform one or more other operations described herein.

In some aspects, a network entity (e.g., a network node 110) may include a communication manager 150. As described in more detail elsewhere herein, the communication manager 150 may receive a first message associated with a scheduling request, the first message including information indicating a request or a notification that is independent of a request for an UL grant. The communication manager 150 may perform an action in accordance with the information. Additionally, or alternatively, the communication manager 150 may perform one or more other operations described herein.

As indicated above, FIG. 1 is provided as an example. Other examples may differ from what is described with regard to FIG. 1.

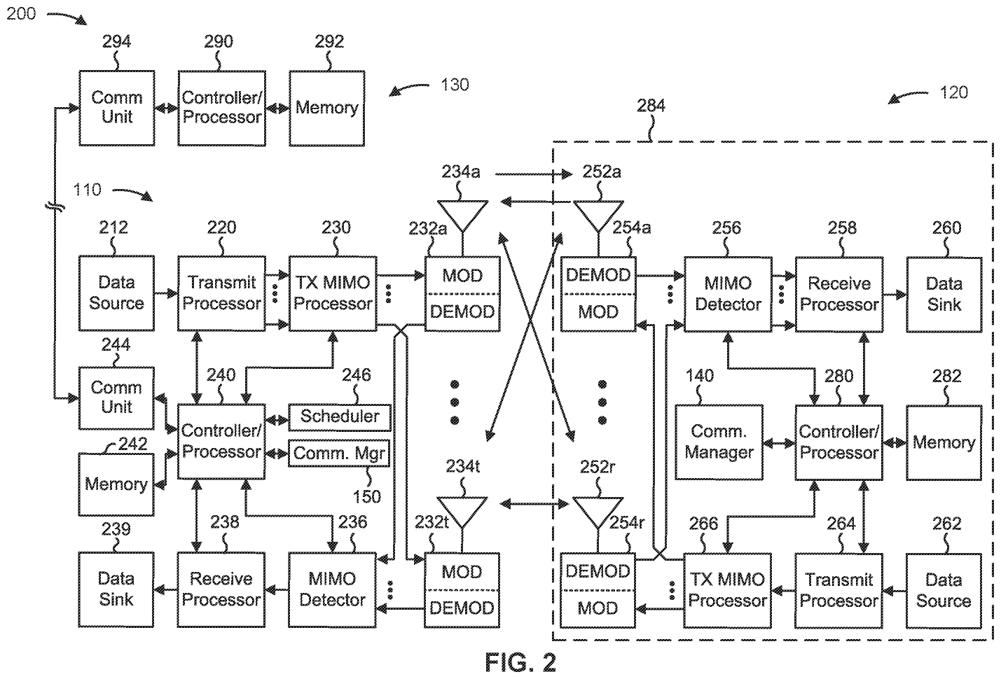

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

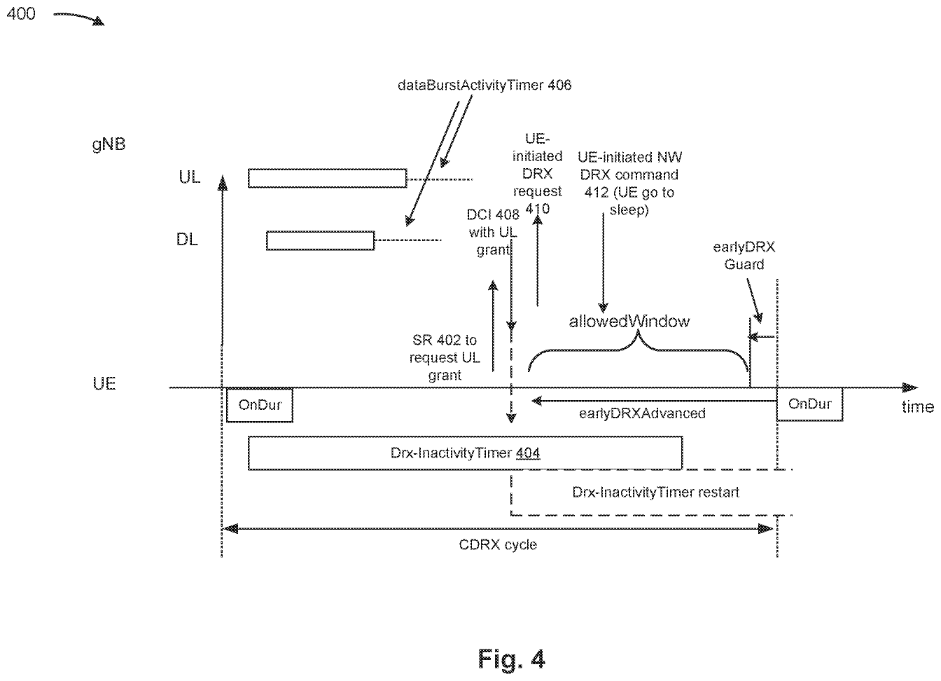

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

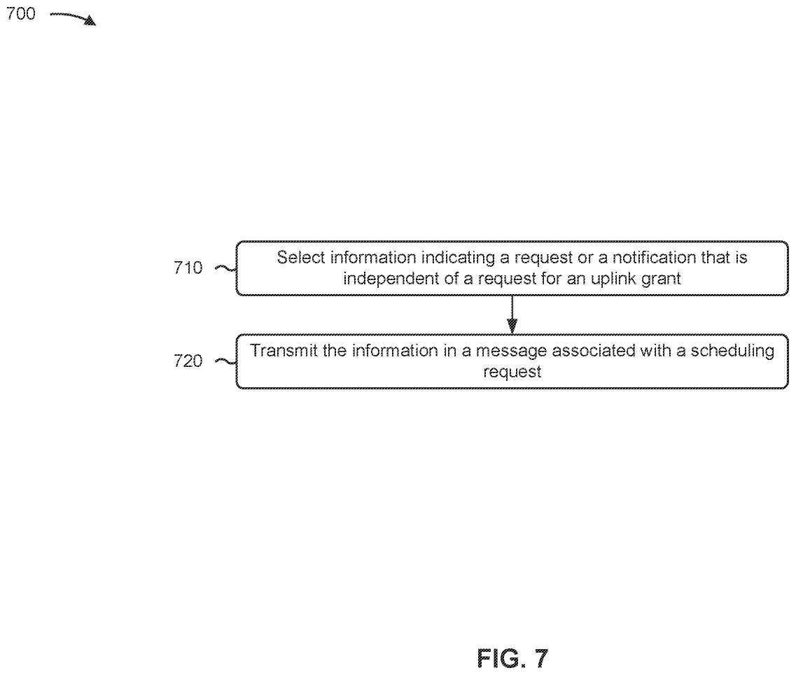

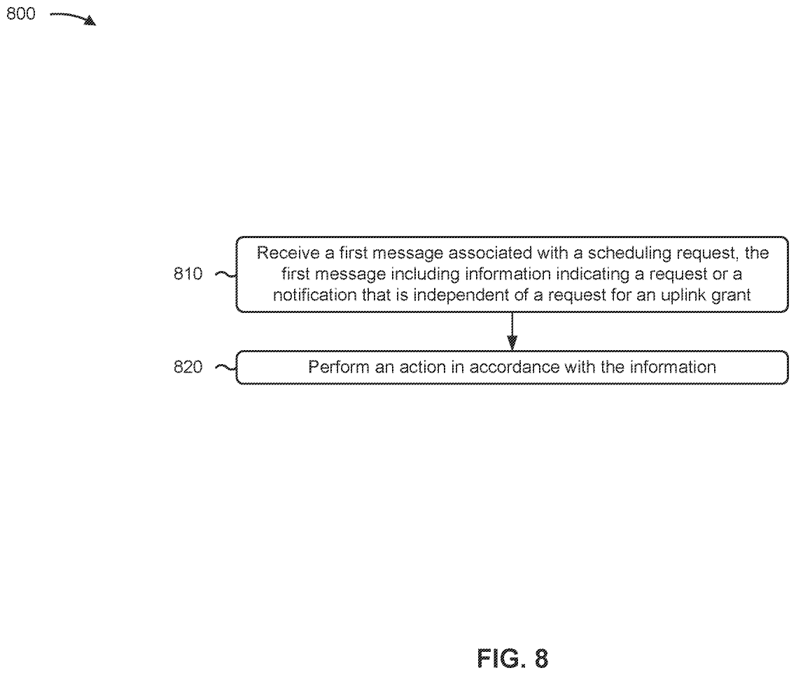

The controller/processor of a network entity (e.g., the controller/processor 240 of the network node 110), the controller/processor 280 of the UE 120, and/or any other component(s) of FIG. 2 may perform one or more techniques associated with an enhanced SR, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a UE (e.g., a UE 120) includes means for selecting information indicating a request or a notification that is independent of a request for an UL grant; and/or means for transmitting the information in a message associated with a scheduling request. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110) includes means for receiving a first message associated with a scheduling request, the first message including information indicating a request or a notification that is independent of a request for an UL grant; and/or means for performing an action in accordance with the information. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

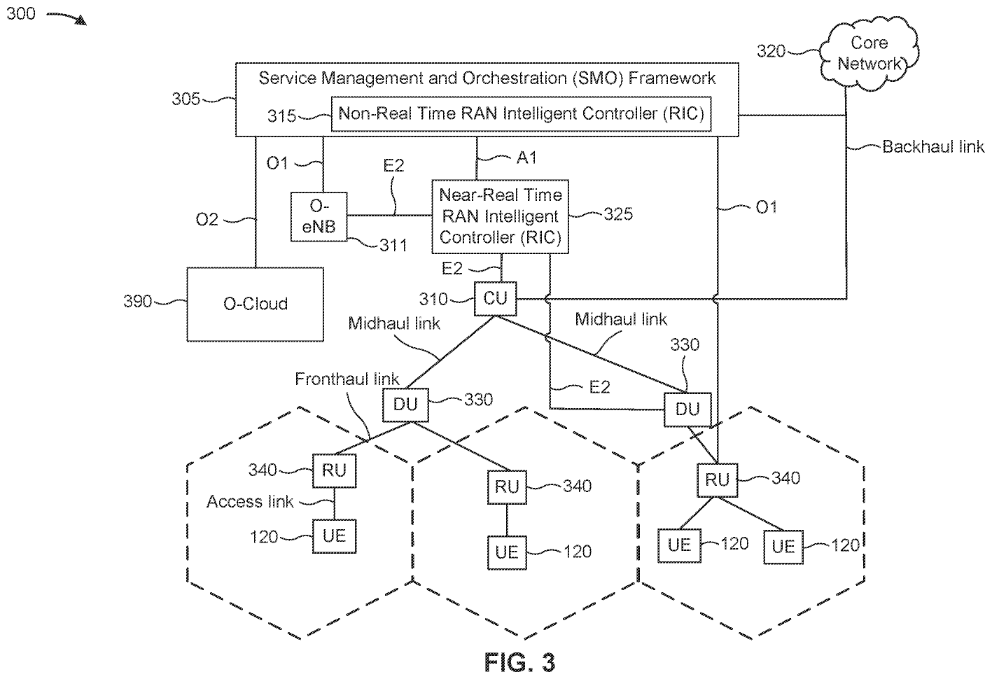

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of an SR, in accordance with the present disclosure.

In some examples, a UE may transmit an SR to request an uplink (UL) grant, such as SR 402 shown in example 400. A PUCCH format 0 or 1 is used to send the SR 402, which can carry two bits or less. SR bit information is one bit, and an ACK or NACK is the other bit. The SR bit only asks for an UL grant. The network entity (e.g., gNB) may transmit DCI 408 with the UL grant. The UE may then transmit a DRX request 410 and receive a DRX command 412. The UE may then go to sleep. This process involves at least four steps, which consumes signaling resources.

The UE may transmit the SR 402 in relation to a CDRX mode. Networks may configure CDRX with a 100 ms inactivity timer (e.g., Drx-InactivityTimer 404). The UE may start the inactivity timer after transmitting or receiving a communication, and enter an inactive mode when the timer expires. This allows the UE to conserve power. The network may also configure the UE with a 160 ms long DRX cycle. The UE may enter DRX early when using a shorter data burst timer (e.g., dataBurstActivityTimer 406) to provide an opportunity for the UE to sleep for some time for these application traffic patterns. This can help to save a significant amount of modem power while upper bounding the delay impact. This power saving feature works when both the UE and network both support enhanced network stack (ENS) signaling and UE-initiated DRX request features (UE can request DRX). ENS is a network proprietary feature based on a common understanding between a UE and an operator. However, for many applications, due to the traffic arrival process, the UE may not get any opportunity to transition to DRX inactive mode in some configurations. For example, the DCI 408 may restart the inactivity timer and not enter DRX early. If the UE is awake for longer than necessary, this wastes UE power.

As indicated above, FIG. 4 is provided as an example. Other examples may differ from what is described with regard to FIG. 4.

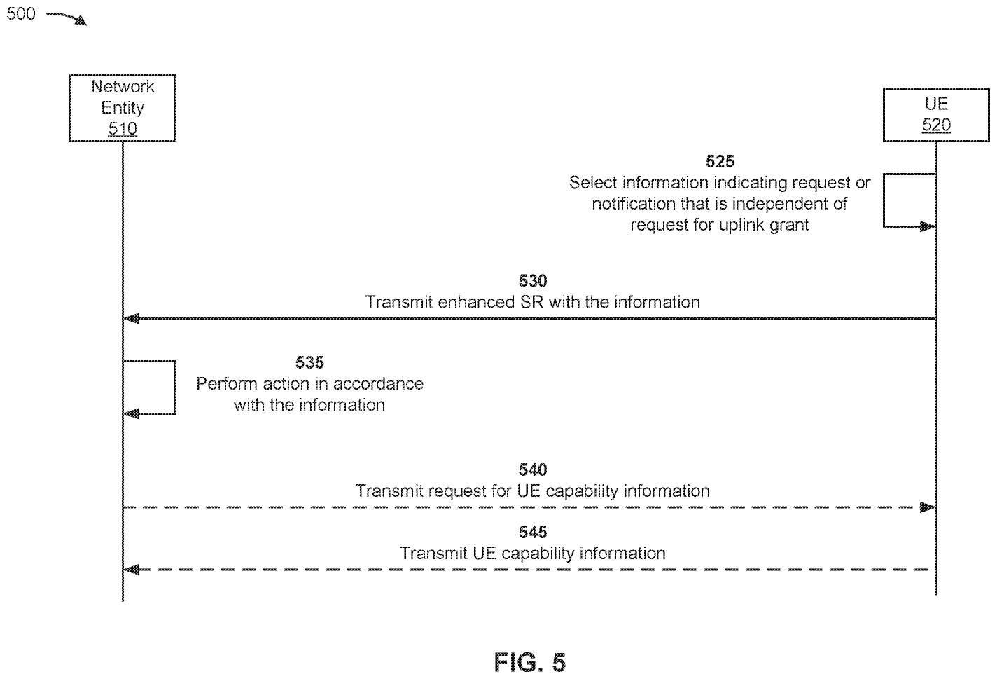

FIG. 5 is a diagram illustrating an example 500 associated with an enhanced SR, in accordance with the present disclosure. As shown in FIG. 5, a network entity 510 (e.g., network node 110) and a UE 520 (e.g., UE 120) may communicate with one another via a wireless network (e.g., wireless communication network 100).

According to various aspects described herein, a UE may transmit an enhanced SR that includes information other than (and is independent of) a request for an UL grant. The information may include a request or an indication that is not a request for an UL grant. That is, the UE may transmit an SR with the information and without a request for an UL grant. For example, if the UE is to take advantage of early DRX and go to sleep early, the UE may transmit an enhanced SR with information that includes a request for a DRX MAC control element (MAC CE) (a network command to go to sleep). By transmitting the request for the DRX MAC CE in the enhanced SR, the UE may request and receive the DRX MAC CE earlier than if the UE were to follow the regular process, where the UE transmits an SR with an UL grant (in order to transmit the DRX request), receives downlink control information (DCI) with the UL grant, and then requests and receives the DRX MAC CE. Using fewer steps allows the UE to sleep earlier, conserve power, and conserve signaling resources. This may also avoid scenarios where the DRX inactivity timer is restarted with the sending of the UL grant, which prevents the UE from going to sleep until the new DRX inactivity timer expires. The enhanced SR allows a request or an indication to be handled at a lower layer (physical (PHY) layer) instead of at the MAC or RRC layers. The handling at the lower layer is faster and consumes less signaling resources and power. Enhanced SR values may be operator controlled and/or agreed upon between the network entity and the UE.

Example 500 shows the use of an enhanced SR. An enhanced SR may include a message associated with an SR that includes information that is independent of a request for an UL grant. In some aspects, the enhanced SR includes the information and does not include a request for an UL grant, even if the enhanced SR is in a format for requesting an UL grant.

As shown by reference number 525, the UE 520 may select information indicating a request or a notification that is independent of a request for an UL grant. In some aspects, the information in the enhanced SR may include 2 or 3 bits that indicate a code for the request for the DRX MAC CE. The enhanced SR may be used for multiple purposes. The enhanced SR may use the same PUCCH format 0 or 1 that carries two bits (and thus have the same reliability). With two bits, the enhanced SR may include one of four values that address four different requests or indications, independent of any request for an UL grant (e.g., without or instead of a request for an UL grant. For example, “00” may be the legacy value indicating that the UE has uplink data in the buffer and needs an UL grant, “01” may be a value indicating the request for the DRX MAC CE, “10” may be another value indicating that the enhanced SR is a probe SR providing a notification (e.g., which bandwidth part (BWP) the UE is operating in currently), and “11” may be a value indicating a request other than for an UL grant (e.g., request for a UE capability enquiry). In some aspects, these values may be indicated with three bits.

As shown by reference number 530, the UE 520 may transmit the enhanced SR. As shown by reference number 535, the network entity 510 may perform an action in accordance with the information.

In some scenarios, the network entity 510 may trigger a radio capability update whenever a radio capability change occurs at the UE 520. Due to some misconfiguration in a carrier aggregation (CA) configuration from the network, the UE 520 may repeatedly indicate a radio link failure (RLF) and to avoid loss of service, the UE 520 may downgrade or remove the UE's CA capability. To update the network entity 510 with its new UE capability, the UE 520 may first release an RRC connection locally and perform a Registration Request procedure (with a radio_cap_update flag as true). The network entity 510 may trigger a UE capability enquiry. The UE 520 may enter the connected state with a new radio capability update. However, whenever the UE 520 enables CA capability again, the UE 520 has to proceed with a Registration Request procedure procedure. Sometimes, the UE 520 may downgrade or upgrade its UE capability due to thermal reasons or operator requirements. Sometimes, based on field issues, the UE 520 may expect to remove an evolved universal terrestrial radio access network (E-UTRAN) NR dual connectivity (ENDC) capability or remove a capability for a few ENDC combinations, and then enable ENDC when issues are mitigated. This type of capability update comes at the cost of losing an active RRC and protocol data unit (PDU) connection and the cost of a fair amount of signaling overhead.

In some aspects, the enhanced SR may include information (e.g., bit value of “11” or “100”) that requests a UE capability update. The network entity 510 may transmit a request for UE capability information, as shown by reference number 540. The UE 520 may respond and transmit the UE capability information, as shown by reference number 545. The UE 520 may provide the UE capability information using the enhanced SR instead of using a non-access stratum (NAS) procedure with multiple messages, which may involve releasing an RRC connection and reconnecting (with release and connect mode messages). The UE 520 may avoid releasing RRC resources and the signaling involved with reestablishing an RRC connection. In this way, the UE 520 may conserve signaling resources.

In some current scenarios, a UE assistance information (UAI) procedure is used to downgrade or upgrade CA and ENDC/NR dual connectivity (NRDC) envelopes, but this consumes signaling resources. RRC messages are involved to release all component carriers in a CA configuration or to release a secondary cell group (SCG) for ENDC/NRDC cases. Using larger RRC UAI messages (e.g., 40-50 bits) for whole SCG releases or for releasing all secondary cells (SCells) consumes signaling resources.

In some aspects, the enhanced SR may include information (e.g., bit value of “101”) that requests a release of one or more SCells (e.g., all SCells). The enhanced SR may include information (e.g., bit value of “110”) that requests release of an SCG. In this way, the UE conserves signaling resources.

In some scenarios, a UE may perform a local RRC release (RRC connection release at the UE and initiated by the UE) several times for various reasons, such as to perform a radio capability update or to save power (e.g., data inactivity timer expiry). In such cases, the network entity may not be aware that the UE is releasing its RRC connection. If the network entity transmits a downlink grant or any other RRC signaling to the UE after the local RRC release, it will be a waste of signaling resources.

In some aspects, the enhanced SR may include information (e.g., bit value of “111”) that indicates the local RRC release. The network entity 510 and the UE 520 may be better synchronized. In this way, the network entity 510 may conserve signaling resources.

As indicated above, FIG. 5 is provided as an example. Other examples may differ from what is described with respect to FIG. 5.

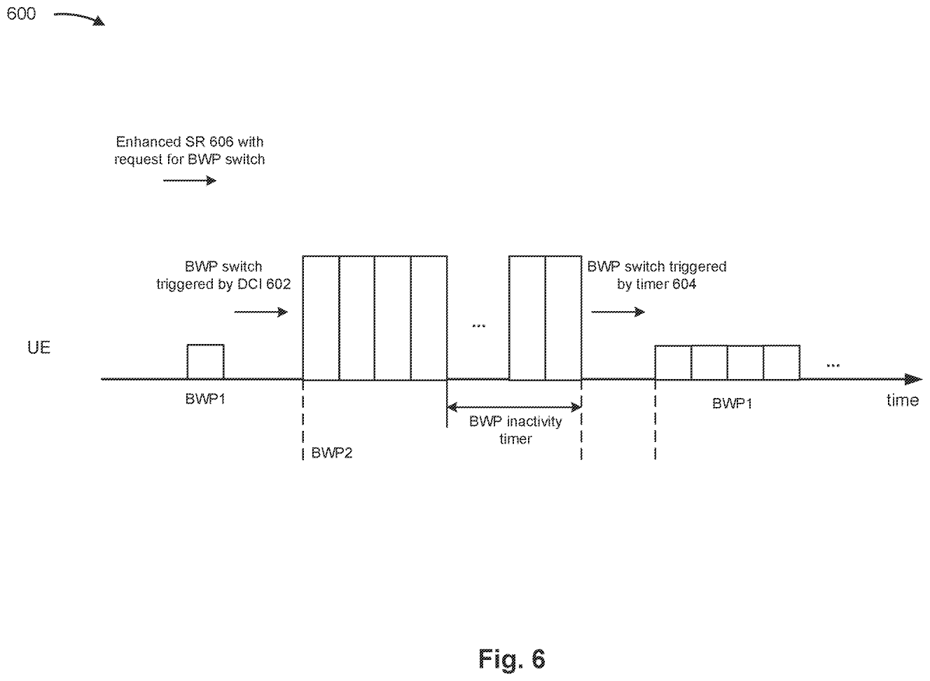

FIG. 6 is a diagram illustrating an example 600 of a BWP switch, in accordance with the present disclosure.

In some scenarios, with multiple subscriber identity modules (SIMs) or subscriptions, a UE may tune away from one SIM toward another SIM (e.g., Sub0 to Sub1). Once the UE returns to Sub0, the UE may indicate to a network entity to resume downlink and uplink activity on Sub0. In this instance, there may not be a need for UL grants, but the network entity may provide some default UL grants, which is a waste of resources at the moment. In these scenarios, there may also be a BWP mismatch, where there is a false DCI grant for a BWP switch after switching from a first BWP to a second BWP. The UE may transmit an SR on the second BWP to see if the network entity has moved to the second BWP. If the network entity gives an UL grant in response to the SR, the UE may assume that the network entity and the UE are synchronized with respect to the BWP. Otherwise, the UE may fall back to the first BWP and transmit an SR to check whether the network entity is on the first BWP. If the UE and the network entity are out of synchronization, UE transmissions may use more bandwidth than necessary.

In some aspects, the enhanced SR may include information that indicates to the network entity which BWP the UE is operating in, such that the network entity and the UE may be in synchronization and operate in the same BWP. For example, the SR may include bit values “10” or “010”. The enhanced SR may help with synchronization rather than request an UL grant. This conserves resources and reduces latency.

In some scenarios, multiple BWPs may be configured for conserving power. A typical configuration may be 100 MHz for BWP1 and 20 MHz for BWP2. Whenever there is a low data/sparse data requirement, the network entity may move the UE to the smaller BWP (e.g., BWP2). Whenever data requirements are high, the network entity may move the UE to the larger BWP (e.g., BWP1). The decision to switch to the smaller size BWP for power and resource savings may be based on detection of a BWP inactivity timer, which is in the range of 80-160 ms. Some networks do not use BWP inactivity-timer-based BWP switching to avoid desynchronization between the UE and the network. These networks may use network-controlled DCI to switch BWPs. Example 600 of FIG. 6 shows DCI-based 602 and timer-based 604 BWP switching. In such scenarios, detection of data inactivity may take time and there may be a delay in sending a BWP switch from a larger BWP to a smaller BWP. This wastes power.

In some aspects, the UE may transmit an enhanced SR 606 with information that requests a BWP switch. For example, the enhanced SR information may include a value “011” for the request. In this way, the network entity may perform a BWP switch and the UE may conserve more power. The enhanced SR may use less signaling than the usual signaling to switch BWPs, and may thus conserve signaling resources.

While various examples of the enhanced SR information have been provided, the enhanced SR may be used for other requests or information. The UE may take advantage of the format and PUCCH message timing of an SR to provide information other than an UL grant in an enhanced SR. SR resources (e.g., PUCCH resources) are configured in the beginning of RRC connection establishment and are always available (unless limited by a maximum SR limit). Accordingly, the enhanced SR may be transmitted at any time.

As indicated above, FIG. 6 is provided as an example. Other examples may differ from what is described with regard to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120, UE 520) performs operations associated with an enhanced SR.

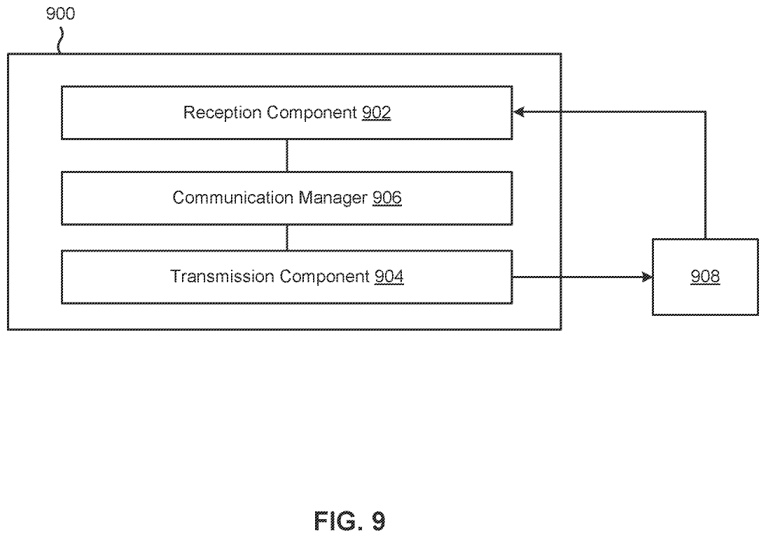

As shown in FIG. 7, in some aspects, process 700 may include selecting information indicating a request or a notification that is independent of a request for an UL grant (block 710). For example, the UE (e.g., using communication manager 906, depicted in FIG. 9) may select information indicating a request or a notification that is independent of a request for an UL grant, as described above.

As further shown in FIG. 7, in some aspects, process 700 may include transmitting the information in a message associated with a scheduling request (block 720). For example, the UE (e.g., using transmission component 904 and/or communication manager 906, depicted in FIG. 9) may transmit the information in a message associated with a scheduling request, as described above.

Process 700 may include additional aspects, such as any single aspect or any combination of aspects described below and/or in connection with one or more other processes described elsewhere herein.

In a first aspect, the message does not include any request for an UL grant.

In a second aspect, alone or in combination with the first aspect, the message is in a format used for requesting an UL grant.

In a third aspect, alone or in combination with one or more of the first and second aspects, the information indicates a request for a DRX MAC CE.

In a fourth aspect, alone or in combination with one or more of the first through third aspects, the information indicates that the UE is entering an inactive state.

In a fifth aspect, alone or in combination with one or more of the first through fourth aspects, the information indicates in which bandwidth part the UE is operating.

In a sixth aspect, alone or in combination with one or more of the first through fifth aspects, the information indicates a request for a BWP switch.

In a seventh aspect, alone or in combination with one or more of the first through sixth aspects, the information indicates a request for a UE capability update.

In an eighth aspect, alone or in combination with one or more of the first through seventh aspects, process 700 includes receiving a request for UE capability information, and transmitting the UE capability information.

In a ninth aspect, alone or in combination with one or more of the first through eighth aspects, the UE capability information is associated with CA or DC (e.g., ENDC, NRDC).

In a tenth aspect, alone or in combination with one or more of the first through ninth aspects, the information indicates an SCG release.

In an eleventh aspect, alone or in combination with one or more of the first through tenth aspects, the information indicates release of one or more secondary cell carriers.

In a twelfth aspect, alone or in combination with one or more of the first through eleventh aspects, the information indicates a local RRC connection release.

In a thirteenth aspect, alone or in combination with one or more of the first through twelfth aspects, the information includes two or three bits.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network entity or an apparatus of a network entity, in accordance with the present disclosure. Example process 800 is an example where the apparatus or the network entity (e.g., network node 110, network entity 510) performs operations associated with an enhanced SR.

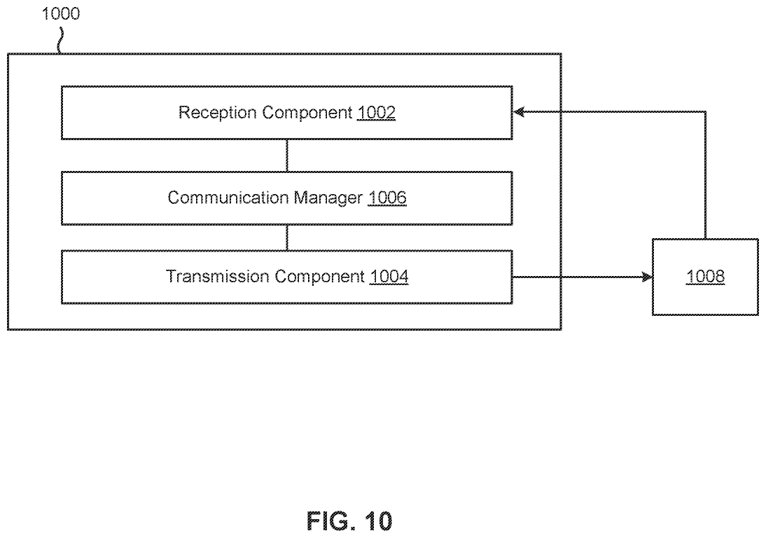

As shown in FIG. 8, in some aspects, process 800 may include receiving a first message associated with a scheduling request, the first message including information indicating a request or a notification that is independent of a request for an UL grant (block 810). For example, the network entity (e.g., using reception component 1002 and/or communication manager 1006, depicted in FIG. 10) may receive a first message associated with a scheduling request, the first message including information indicating a request or a notification that is independent of a request for an UL grant, as described above.

As further shown in FIG. 8, in some aspects, process 800 may include performing an action in accordance with the information (block 820). For example, the network entity (e.g., using communication manager 1006, depicted in FIG. 10) may perform an action in accordance with the information, as described above.

Process 800 may include additional aspects, such as any single aspect or any combination of aspects described below and/or in connection with one or more other processes described elsewhere herein.

In a first aspect, the first message does not include a request for an UL grant.

In a second aspect, alone or in combination with the first aspect, the first message is in a format used for requesting an UL grant.

In a third aspect, alone or in combination with one or more of the first and second aspects, the information indicates a request for a DRX MAC CE, and performing the action includes transmitting a second message including the DRX MAC CE.

In a fourth aspect, alone or in combination with one or more of the first through third aspects, the information indicates that a UE is entering an inactive state, and performing the action includes refraining from transmitting a communication to the UE in accordance with the inactive state of the UE.

In a fifth aspect, alone or in combination with one or more of the first through fourth aspects, the information indicates in which BWP a UE is operating, and performing the action includes transmitting a second message in the BWP.

In a sixth aspect, alone or in combination with one or more of the first through fifth aspects, the information indicates a request for a BWP switch, and performing the action includes transmitting a second message indicating the BWP switch.

In a seventh aspect, alone or in combination with one or more of the first through sixth aspects, the information indicates a request for a UE capability update, and performing the action includes transmitting a request for UE capability information and receiving the UE capability information.

In an eighth aspect, alone or in combination with one or more of the first through seventh aspects, the UE capability information is associated with carrier aggregation or dual connectivity.

In a ninth aspect, alone or in combination with one or more of the first through eighth aspects, the information indicates an SCG release, and performing the action includes releasing secondary carriers of the SCG.

In a tenth aspect, alone or in combination with one or more of the first through ninth aspects, the information indicates a local RRC connection release, and performing the action includes releasing resources in accordance with the RRC connection release.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may select information indicating a request or a notification that is independent of a request for an UL grant. The transmission component 904 may transmit the information in a message associated with a scheduling request.

The reception component 902 may receive a request for UE capability information. The transmission component 904 may transmit the UE capability information.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network entity, or a network entity may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 1-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network entity described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the network entity described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the network entity described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive a first message associated with a scheduling request, the first message including information indicating a request or a notification that is independent of a request for an UL grant. The communication manager 1006 may perform an action in accordance with the information.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a user equipment (UE), comprising: selecting information indicating a request or a notification that is independent of a request for an uplink grant; and transmitting the information in a message associated with a scheduling request.
Aspect 2: The method of Aspect 1, wherein the message does not include any request for an uplink grant.
Aspect 3: The method of Aspect 2, wherein the message is in a format used for requesting an uplink grant.
Aspect 4: The method of any of Aspects 1-3, wherein the information indicates a request for a discontinuous reception medium access control control element (MAC CE).
Aspect 5: The method of any of Aspects 1-4, wherein the information indicates that the UE is entering an inactive state.
Aspect 6: The method of any of Aspects 1-5, wherein the information indicates in which bandwidth part the UE is operating.
Aspect 7: The method of any of Aspects 1-6, wherein the information indicates a request for a bandwidth part switch.
Aspect 8: The method of any of Aspects 1-7, wherein the information indicates a request for a UE capability update.
Aspect 9: The method of Aspect 8, further comprising: receiving a request for UE capability information; and transmitting the UE capability information.
Aspect 10: The method of Aspect 9, wherein the UE capability information is associated with carrier aggregation or dual connectivity.
Aspect 11: The method of any of Aspects 1-10, wherein the information indicates a secondary cell group release.
Aspect 12: The method of any of Aspects 1-11, wherein the information indicates release of one or more secondary cell carriers.
Aspect 13: The method of any of Aspects 1-12, wherein the information indicates a local radio resource control connection release.
Aspect 14: The method of any of Aspects 1-13, wherein the information includes two or three bits.
Aspect 15: A method of wireless communication performed by a network entity, comprising: receiving a first message associated with a scheduling request, the first message including information indicating a request or a notification that is independent of a request for an uplink grant; and performing an action in accordance with the information.
Aspect 16: The method of Aspect 15, wherein the first message does not include a request for an uplink grant.
Aspect 17: The method of Aspect 16, wherein the first message is in a format used for requesting an uplink grant.
Aspect 18: The method of any of Aspects 15-17, wherein the information indicates a request for a discontinuous reception (DRX) medium access control control element (MAC CE), and wherein performing the action includes transmitting a second message including the DRX MAC CE.
Aspect 19: The method of any of Aspects 15-18, wherein the information indicates that a user equipment (UE) is entering an inactive state, and wherein performing the action includes refraining from transmitting a communication to the UE in accordance with the inactive state of the UE.
Aspect 20: The method of any of Aspects 15-19, wherein the information indicates in which bandwidth part (BWP) a user equipment (UE) is operating, and wherein performing the action includes transmitting a second message in the BWP.
Aspect 21: The method of any of Aspects 15-20, wherein the information indicates a request for a bandwidth part (BWP) switch, and wherein performing the action includes transmitting a second message indicating the BWP switch.
Aspect 22: The method of any of Aspects 15-21, wherein the information indicates a request for a user equipment (UE) capability update, and wherein performing the action includes: transmitting a request for UE capability information; and receiving the UE capability information.
Aspect 23: The method of Aspect 22, wherein the UE capability information is associated with carrier aggregation or dual connectivity.
Aspect 24: The method of any of Aspects 15-23, wherein the information indicates a secondary cell group (SCG) release, and wherein performing the action includes releasing secondary carriers of the SCG.
Aspect 25: The method of any of Aspects 15-24, wherein the information indicates a local radio resource control (RRC) connection release, and wherein performing the action includes releasing resources in accordance with the RRC connection release.
Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.
Aspect 27: An apparatus for wireless communication at a device, the apparatus comprising one or more memories and one or more processors coupled to the one or more memories, the one or more processors configured to cause the device to perform the method of one or more of Aspects 1-25.
Aspect 28: An apparatus for wireless communication, the apparatus comprising at least one means for performing the method of one or more of Aspects 1-25.
Aspect 29: A non-transitory computer-readable medium storing code for wireless communication, the code comprising instructions executable by one or more processors to perform the method of one or more of Aspects 1-25.
Aspect 30: A non-transitory computer-readable medium storing a set of instructions for wireless communication, the set of instructions comprising one or more instructions that, when executed by one or more processors of a device, cause the device to perform the method of one or more of Aspects 1-25.
Aspect 31: A device for wireless communication, the device comprising a processing system that includes one or more processors and one or more memories coupled with the one or more processors, the processing system configured to cause the device to perform the method of one or more of Aspects 1-25.
Aspect 32: An apparatus for wireless communication at a device, the apparatus comprising one or more memories and one or more processors coupled to the one or more memories, the one or more processors individually or collectively configured to cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, individually or collectively configured to cause the UE to:
select information indicating a request or a notification that is independent of a request for an uplink grant; and
transmit the information in a message associated with a scheduling request.

2. The apparatus of claim 1, wherein the message does not include any request for an uplink grant.

3. The apparatus of claim 2, wherein the message is in a format used for requesting an uplink grant.

4. The apparatus of claim 1, wherein the information indicates a request for a discontinuous reception medium access control control element (MAC CE).

5. The apparatus of claim 1, wherein the information indicates that the UE is entering an inactive state.

6. The apparatus of claim 1, wherein the information indicates in which bandwidth part the UE is operating.

7. The apparatus of claim 1, wherein the information indicates a request for a bandwidth part switch.

8. The apparatus of claim 1, wherein the information indicates a request for a UE capability update.

9. The apparatus of claim 8, wherein the one or more processors are individually or collectively configured to cause the UE to:
receive a request for UE capability information; and
transmit the UE capability information.

10. The apparatus of claim 9, wherein the UE capability information is associated with carrier aggregation or dual connectivity.

11. The apparatus of claim 1, wherein the information indicates a secondary cell group release.

12. The apparatus of claim 1, wherein the information indicates release of one or more secondary cell carriers.

13. The apparatus of claim 1, wherein the information indicates a local radio resource control connection release.

14. The apparatus of claim 1, wherein the information includes two or three bits.

15. An apparatus for wireless communication at a network entity, comprising:
one or more memories; and
one or more processors, coupled to the one or more memories, individually or collectively configured to cause the network entity to:
receive a first message associated with a scheduling request, the first message including information indicating a request or a notification that is independent of a request for an uplink grant; and
perform an action in accordance with the information.

16. The apparatus of claim 15, wherein the first message does not include a request for an uplink grant.

17. The apparatus of claim 16, wherein the first message is in a format used for requesting an uplink grant.

18. The apparatus of claim 15, wherein the information indicates a request for a discontinuous reception (DRX) medium access control control element (MAC CE), and wherein performing the action includes transmitting a second message including the DRX MAC CE.

19. The apparatus of claim 15, wherein the information indicates that a user equipment (UE) is entering an inactive state, and wherein to perform the action, the one or more processors are individually or collectively configured to cause the network entity to refrain from transmitting a communication to the UE in accordance with the inactive state of the UE.

20. The apparatus of claim 15, wherein the information indicates in which bandwidth part (BWP) a user equipment (UE) is operating, and wherein to perform the action, the one or more processors are individually or collectively configured to cause the network entity to transmit a second message in the BWP.

21. The apparatus of claim 15, wherein the information indicates a request for a bandwidth part (BWP) switch, and wherein to perform the action, the one or more processors are individually or collectively configured to cause the network entity to transmit a second message indicating the BWP switch.

22. The apparatus of claim 15, wherein the information indicates a request for a user equipment (UE) capability update, and wherein to perform the action, the one or more processors are individually or collectively configured to cause the network entity to:
transmit a request for UE capability information; and
receive the UE capability information.

23. The apparatus of claim 22, wherein the UE capability information is associated with carrier aggregation or dual connectivity.

24. The apparatus of claim 15, wherein the information indicates a secondary cell group (SCG) release, and wherein performing the action includes releasing secondary carriers of the SCG.

25. The apparatus of claim 15, wherein the information indicates a local radio resource control (RRC) connection release, and wherein performing the action includes releasing resources in accordance with the RRC connection release.

26. A method of wireless communication performed by a user equipment (UE), comprising:
selecting information indicating a request or a notification that is independent of a request for an uplink grant; and
transmitting the information in a message associated with a scheduling request.

27. The method of claim 26, wherein the information indicates that the UE is entering an inactive state or indicates in which bandwidth part the UE is operating.

28. The method of claim 26, wherein the information indicates a request for a discontinuous reception medium access control control element (MAC CE), a request for a bandwidth part switch, or a request for a UE capability update.

29. The method of claim 26, wherein the information indicates a secondary cell group release, release of one or more secondary cell carriers, or a local radio resource control connection release.

30. A method of wireless communication performed by a network entity, comprising:
receiving a first message associated with a scheduling request, the first message including information indicating a request or a notification that is independent of a request for an uplink grant; and
performing an action in accordance with the information.
